(19) United States
(12) Patent Application Publication
(10) Pub. No.: US 2023/0368403 A1
(43) Pub. Date: Nov. 16, 2023

(54) SYSTEMS AND METHODS FOR FACILITATING DISPLAY MISALIGNMENT CORRECTION

(71) Applicant: Microsoft Technology Licensing, LLC, Redmond, WA (US)

(72) Inventors: Michaela PORUBANOVA, Seattle, WA (US); Erick Joseph PAUL, Bothell, WA (US); Robert Thomas HELD, Seattle, WA (US); Rayna DEMASTER-SMITH, Duvall, WA (US); Georg KLEIN, Bellevue, WA (US)

(21) Appl. No.: 17/745,682

(22) Filed: May 16, 2022

(51) Int. Cl. G06T 7/285; G06T 19/00; G06T 3/60; H04N 19/51

(52) U.S. Cl. CPC G06T 7/285; G06T 19/006; G06T 3/60; H04N 19/51; G06T 2207/10021

(57) ABSTRACT

A system for facilitating display misalignment correction includes one or more processors and one or more hardware storage devices storing instructions that are executable by the one or more processors to configure the system to (i) determine one or more user activity attributes associated with user operation of a stereoscopic display system, (ii) based on the one or more user activity attributes, determine one or more correction application attributes, the one or more correction application attributes indicating a manner of applying one or more display misalignment correction operations to align presentation of content in the stereoscopic display system, and (iii) apply the one or more display misalignment correction operations to align the presentation of the content in the stereoscopic display system in accordance with the one or more correction application attributes, thereby effectuating display misalignment correction in a manner that mitigates user discomfort.

### BACKGROUND

Mixed-reality (MR) systems, including virtual-reality and augmented-reality systems, have received significant attention because of their ability to create truly unique experiences for their users. For reference, conventional virtual-reality (VR) systems create a completely immersive experience by restricting their users' views to only a virtual environment. This is often achieved, in VR systems, through the use of a head-mounted device (HMD) that completely blocks any view of the real world. As a result, a user is entirely immersed within the virtual environment. In contrast, conventional augmented-reality (AR) systems create an augmented-reality experience by visually presenting virtual objects that are placed in or that interact with the real world.

As used herein, VR and AR systems are described and referenced interchangeably. Unless stated otherwise, the descriptions herein apply equally to all types of mixed-reality systems, which (as detailed above) includes AR systems, VR reality systems, and/or any other similar system capable of displaying virtual objects.

MR systems typically include separate display components configured for arrangement in front of separate eyes of a user to facilitate display of content to the user. The content displayed via the separate display components usually at least partially differs as between the separate display components to enable the separate display components to complement one another in facilitating a stereoscopic viewing experience for the user. Such differences can enable display of content that can be perceived by users as being positioned at desired depths/locations within a mixed-reality scene.

However, stereoscopic misalignments often occur in MR systems, where content displayed via the separate display components is not properly aligned. Stereoscopic misalignments can result in users perceiving the displayed content in an undesirable manner within the mixed-reality scene. For example, stereoscopic misalignments can cause users to misperceive hologram or virtual object size and/or location in space, which can degrade user experiences (e.g., especially in experiences where users are meant to interact with holograms). Stereoscopic misalignments can additionally or alternatively result in visual strain, visual discomfort, and/or vestibular discomfort for users.

There exists a need for improved systems and techniques for addressing stereoscopic misalignments, particularly in MR systems.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Disclosed embodiments include systems, methods, and devices for facilitating display misalignment correction.

Some embodiments provide a system that includes one or more processors and one or more hardware storage devices storing instructions that are executable by the one or more processors to configure the system to (i) determine one or more user activity attributes associated with user operation of a stereoscopic display system, (ii) based on the one or more user activity attributes, determine one or more correction application attributes, the one or more correction application attributes indicating a manner of applying one or more display misalignment correction operations to align presentation of content in the stereoscopic display system, and (iii) apply the one or more display misalignment correction operations to align the presentation of the content in the stereoscopic display system in accordance with the one or more correction application attributes, thereby effectuating display misalignment correction in a manner that mitigates user discomfort and/or prevents disruption of user experience.

Some embodiments provide a system that includes one or more processors and one or more hardware storage devices storing instructions that are executable by the one or more processors to configure the system to (i) determine one or more display misalignment correction operations to be applied to align presentation of content in a stereoscopic display system, (ii) based on the one or more display misalignment correction operations, determine one or more correction application attributes, the one or more correction application attributes indicating a manner of applying the one or more display misalignment correction operations to align the presentation of the content in the stereoscopic display system, and (iii) apply the one or more display misalignment correction operations to align the presentation of the content in the stereoscopic display system in accordance with the one or more correction application attributes, thereby effectuating display misalignment correction in a manner that mitigates user discomfort.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates example components of an example system that may include or be used to implement one or more disclosed embodiments;

FIG. 2A illustrates a conceptual representation of display misalignments and correction operations associated with a head-mounted display (HMD);

FIG. 2B illustrates a conceptual depiction of activity attributes that can be embodied by an HMD during presentation of virtual content;

FIG. 2C illustrates a conceptual representation of correction application attributes that may be determined based upon activity attributes associated with an HMD and/or a type of display misalignment correction operation determined as beneficial for continued use of the HMD;

FIG. 2D illustrates a conceptual representation of performing a display misalignment correction operation based upon correction application attributes; and

FIGS. 3 and 4 illustrate example flow diagrams depicting acts associated with facilitating display misalignment correction, in accordance with implementations of the present disclosure.

### DETAILED DESCRIPTION

Disclosed embodiments are generally directed to systems and methods for facilitating display misalignment correction, such as for mixed reality devices.

### Examples of Technical Benefits, Improvements, and Practical Applications

Those skilled in the art will recognize, in view of the present disclosure, that at least some of the disclosed embodiments may be implemented to address various shortcomings associated with at least some conventional approaches for addressing stereoscopic misalignment in display systems. The following section outlines some example improvements and/or practical applications provided by the disclosed embodiments. It will be appreciated, however, that the following are examples only and that the embodiments described herein are in no way limited to the example improvements discussed herein.

As noted above, stereoscopic display misalignments can cause various user experience issues in display systems (e.g., MR HMDs). In some instances, display misalignment is caused by physical and/or thermal deformations, which can arise after production of devices and can change and/or exacerbate over time. Various methods exist for detecting and correcting for display misalignment on display devices in production. However, existing techniques for addressing display misalignments involve instantly correcting for display misalignments upon detection of such misalignments. Misalignment corrections can manifest to users as a change in the position of holograms/virtual content. Such immediate or abrupt misalignment corrections can be disruptive to user experiences, even though such corrections attempt to remove disruptions to user experiences.

Disclosed embodiments include modifying the attributes of misalignment corrections to be performed based on the activity context associated with display devices. For example, disclosed techniques involve determining user activity attributes associated with user operation of a display system. User activity attributes may include, for example, an amount of motion associated with the display system (e.g., caused by user head movements). A system may dynamically determine attributes for applying a misalignment correction operation based on the activity attributes. An attribute for applying the misalignment correction may include speed of correction. As one example, the speed of correction may be selected to be faster when the activity attributes indicate that the system is experiencing (or is expected to continue experiencing) a threshold amount of motion, whereas the speed of correction may be selected to be slower when the activity attributes indicate that the system is experiencing (or is expected to continue experiencing) a low amount of motion. The misalignment correction may then be applied in accordance with the dynamically determined attributes (e.g., speed of correction) for doing so.

Accordingly, disclosed embodiments may advantageously tailor the application of a misalignment operation for a display system to the use context of the display system. Such functionality may provide systems that can advantageously facilitate display misalignment correction in a manner that is less disruptive to user experiences and/or in a manner that improves user comfort. Thus, disclosed systems may, in some instances, minimize the deleterious effects of display misalignment corrections.

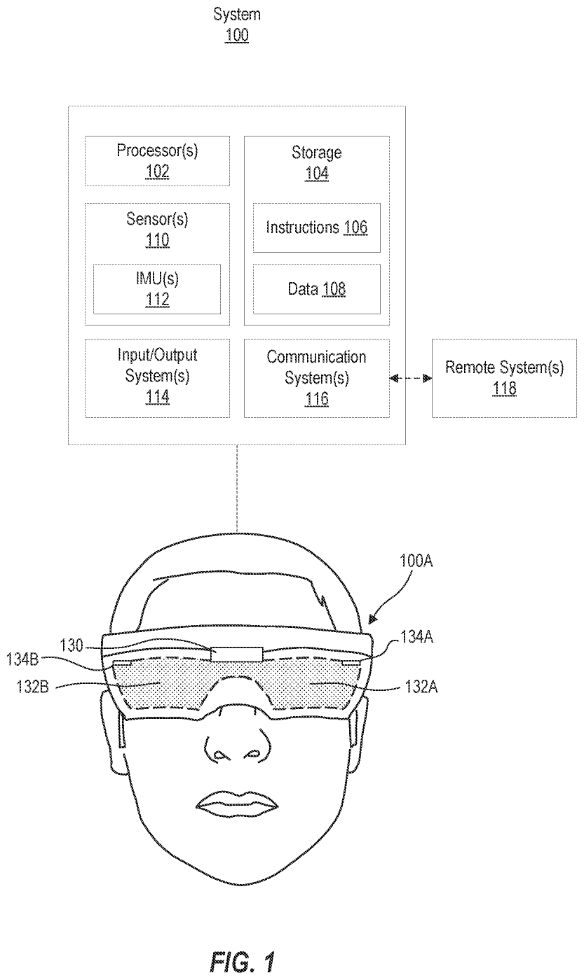

Having just described some of the various high-level features and benefits of the disclosed embodiments, attention will now be directed to FIGS. 1 through 4. These Figures illustrate various conceptual representations, architectures, methods, and supporting illustrations related to the disclosed embodiments.

### Example Systems and Techniques for Facilitating Display Misalignment Correction

FIG. 1 illustrates various example components of a system 100 that may be used to implement one or more disclosed embodiments. For example, FIG. 1 illustrates that a system 100 may include processor(s) 102, storage 104, sensor(s) 110, input/output system(s) 114 (I/O system(s) 114), and communication system(s) 116. Although FIG. 1 illustrates a system 100 as including particular components, one will appreciate, in view of the present disclosure, that a system 100 may comprise any number of additional or alternative components.

The processor(s) 102 may comprise one or more sets of electronic circuitries that include any number of logic units, registers, and/or control units to facilitate the execution of computer-readable instructions (e.g., instructions that form a computer program). Such computer-readable instructions may be stored within storage 104. The storage 104 may comprise physical system memory and may be volatile, non-volatile, or some combination thereof. Furthermore, storage 104 may comprise local storage, remote storage (e.g., accessible via communication system(s) 116 or otherwise), or some combination thereof. Additional details related to processors (e.g., processor(s) 102) and computer storage media (e.g., storage 104) will be provided hereinafter.

In some implementations, the processor(s) 102 may comprise or be configurable to execute any combination of software and/or hardware components that are operable to facilitate processing using machine learning models or other artificial intelligence-based structures/architectures. For example, processor(s) 102 may comprise and/or utilize hardware components or computer-executable instructions operable to carry out function blocks and/or processing layers configured in the form of, by way of non-limiting example, single-layer neural networks, feed forward neural networks, radial basis function networks, deep feed-forward networks, recurrent neural networks, long-short term memory (LSTM) networks, gated recurrent units, autoencoder neural networks, variational autoencoders, denoising autoencoders, sparse autoencoders, Markov chains, Hopfield neural networks, Boltzmann machine networks, restricted Boltzmann machine networks, deep belief networks, deep convolutional networks (or convolutional neural networks), deconvolutional neural networks, deep convolutional inverse graphics networks, generative adversarial networks, liquid state machines, extreme learning machines, echo state networks, deep residual networks, Kohonen networks, support vector machines, neural Turing machines, and/or others.

As will be described in more detail, the processor(s) 102 may be configured to execute instructions 106 stored within storage 104 to perform certain actions associated with facilitating display misalignment corrections. The actions may rely at least in part on data 108 stored on storage 104 in a volatile or non-volatile manner.

In some instances, the actions may rely at least in part on communication system(s) 116 for receiving data from remote system(s) 118, which may include, for example, separate systems or computing devices, sensors, and/or others. The communications system(s) 118 may comprise any combination of software or hardware components that are operable to facilitate communication between on-system components/devices and/or with off-system components/devices. For example, the communications system(s) 118 may comprise ports, buses, or other physical connection apparatuses for communicating with other devices/components. Additionally, or alternatively, the communications system(s) 118 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 1 illustrates that a system 100 may comprise or be in communication with sensor(s) 110. Sensor(s) 110 may comprise any device for capturing or measuring data representative of perceivable or detectable phenomena. By way of non-limiting example, the sensor(s) 110 may comprise one or more image sensors, microphones, thermometers, barometers, magnetometers, accelerometers, gyroscopes, and/or others.

FIG. 1 illustrates that the sensor(s) 110 may comprise inertial measurement unit(s) 112 (IMU(s) 112), which may include a combination of one or more accelerometers, gyroscopes, and/or magnetometers. IMU(s) 112 may be used to track or obtain data indicating motion attributes of the system 100 (e.g., inertial tracking data), such as 3 degrees of freedom (3DOF) pose data for the system 100 (e.g., yaw, pitch, roll pose data). In some instances, inertial tracking data obtained via IMU(s) 112 is combined with visual tracking data (which may be obtained based on imagery captured utilizing one or more image sensors) to provide 6 degrees of freedom (6DOF) pose data for the system 100 (e.g., x, y, z, yaw, pitch, roll pose data), such as by performing simultaneous localization and mapping (SLAM).

Furthermore, FIG. 1 illustrates that a system 100 may comprise or be in communication with I/O system(s) 114. I/O system(s) 114 may include any type of input or output device such as, by way of non-limiting example, a touch screen, a mouse, a keyboard, a controller, a speaker, and/or others, without limitation. For example, the I/O system(s) 114 may include a display system that may comprise any number of display panels, optics, laser scanning display assemblies, and/or other components.

FIG. 1 conceptually represents that the components of the system 100 may comprise or utilize a head-mounted display 100A (HMD 100A). Although the present description focuses, in at least some respects, on utilizing an HMD to implement techniques of the present disclosure, additional or alternative types of systems may be used.

The HMD 100A of FIG. 1 includes separate display components for displaying images to the user's left eye. In particular, FIG. 1 depicts the HMD 100A as including display 132A configured for displaying images to the user's left eye and display 132B configured for displaying images to the user's right eye. The displays 132A and 132B of FIG. 1 may comprise surface relief grating (SRG) displays configured to out-couple light emitted by light source(s) 130 (e.g., laser scanning/projecting components with microelectromechanical mirrors) and internally reflected toward/through the displays 132A and 132B. Other types of display devices are within the scope of the present disclosure (e.g., back-lit display panels such as LED displays, LCOS displays, etc.).

The HMD 100A may comprise one or more detectors 134A and 134B configured to detect at least a portion of the light emitted by the light source(s) 130. For instance, the one or more detectors 134A and 134B may be arranged to detect a test portion of display imagery output by the light source(s) 130, which may comprise a test pattern/image. The test pattern/image as detected by the detector(s) 134A and 134B may enable the HMD 100A to determine whether stereoscopic misalignments exist in the output of the light source(s) 130 (e.g., based upon distortions or deviations in the detected test pattern/image from an expected form of the test pattern/image). The HMD 100A may then determine appropriate misalignment correction operations to perform to correct for the detected stereoscopic misalignment (e.g., transformations configured to correct for the distortions/deviations detected in the test pattern/image as detected by the detector(s) 134A and 134B).

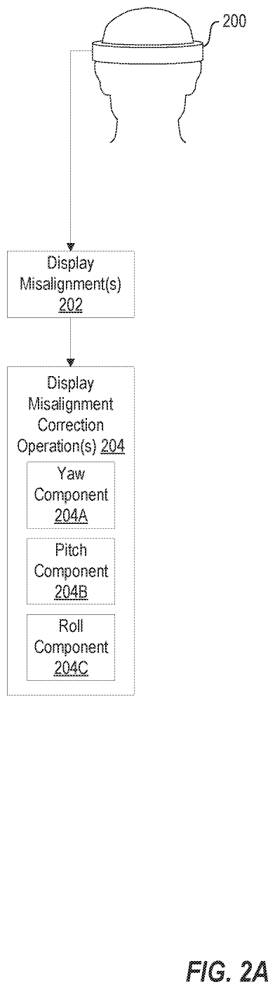

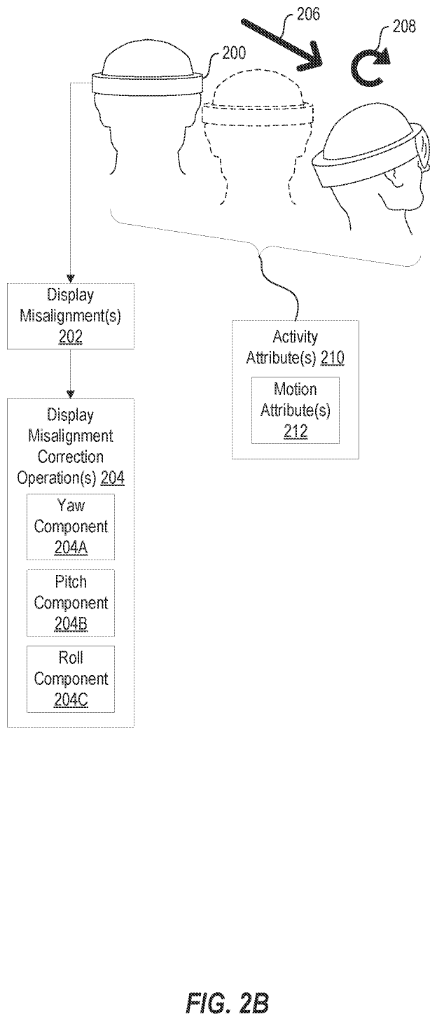

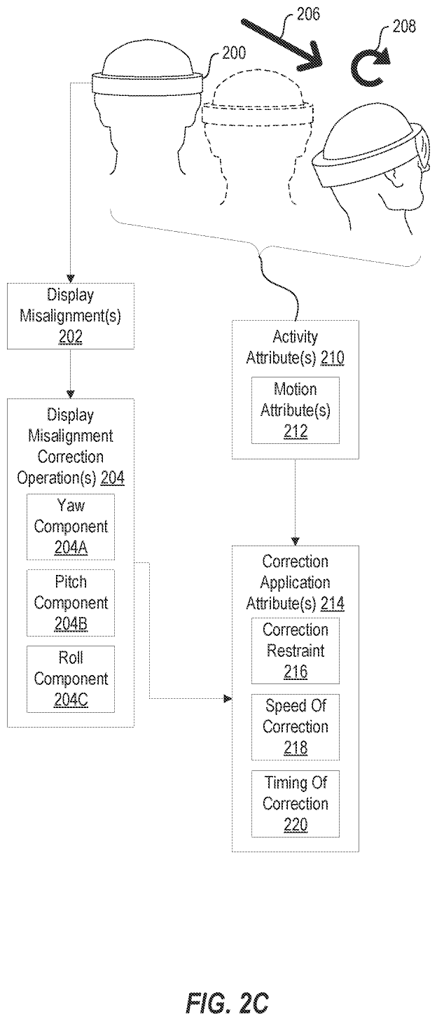

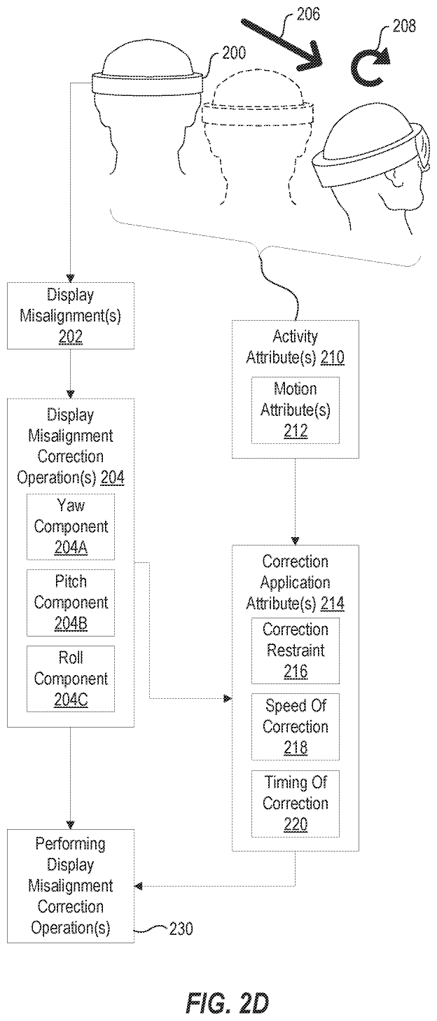

FIG. 2A illustrates an HMD 200, which corresponds in at least some respects to the HMD 100A discussed hereinabove with reference to FIG. 1. For instance, the HMD 200 may comprise detectors for detecting display misalignment(s) 202 between two displays for displaying content to separate eyes of a user (e.g., as discussed above). Based upon the detected display misalignment(s) 202, the HMD 200 (or any system) may determine display misalignment correction operation(s) 204 configured for correcting the display misalignment(s) 202 to restore or improve the user experience (e.g., by aligning the presentation of content as between the two displays). As depicted in FIG. 2, the display misalignment correction operation(s) 204 may comprise various components, such as a yaw component 204A, a pitch component 204B, and/or a roll component 204C. A yaw component 204A of display misalignment correction operation(s) 204 may comprise a correction configured to address errors in the distance/depth of displayed virtual objects. A pitch component 204B of display misalignment correction operation(s) 204 may comprise a correction configured to address errors in vertical positioning of displayed virtual objects. A roll component 204C of display misalignment correction operation(s) 204 may comprise a correction configured to address a combination of pitch and yaw misalignments based on the eccentricity of displayed virtual objects about a center of the display.

As noted above, immediately applying display misalignment correction operation(s) 204 may result in user discomfort. For example, abrupt corrections to the position of holograms/virtual objects can be disorienting, confusing, and/or unsafe for users. Accordingly, disclosed embodiments are directed to systems that enable application of display misalignment correction operation(s) 204 in a manner that can reduce user discomfort throughout the application of such corrections.

FIG. 2B depicts that, in some instances, the HMD 200 may experience (or be expected to experience) motion and/or other physical/positional changes throughout use of the HMD 200. For instance, FIG. 2B illustrates the user operating the HMD translating head positioning (e.g., via arrow 206) and/or rotating head positioning (e.g., via arrow 208). Such motion and/or other physical/positional changes of the HMD 200 may be quantified as activity attribute(s) 210. Activity attribute(s) 210 may include, for example, motion attribute(s) 212 of the HMD 200. Motion attribute(s) may comprise various metrics associated with motion/manipulation of the HMD 200, such as amount of motion (e.g., motion experienced over a time period/unit), linear velocity, linear acceleration, angular velocity, angular acceleration, and/or others. Such motion attribute(s) 212 may be obtained via IMU(s) 112 and/or other sensor(s) 110, as discussed above. Activity attribute(s) 210 may additionally or alternatively include other components, such as virtual experience/environment context, prevalence of holograms/virtual objects in the scene, whether user gaze coincides with hologram/virtual object location, and/or others.

The activity attribute(s) 210 associated with an HMD 200 (or other system) may provide a basis for determining a manner in which to apply misalignment corrections to render the application of such misalignment corrections less disruptive to user experiences. FIG. 2C illustrates correction application attribute(s) 214, which may define a manner of applying the display misalignment correction operation(s) 204. The correction application attribute(s) 214 may be determined based upon the activity attribute(s) 210 and/or the display misalignment correction operation(s) 204 to be performed (as indicated in FIG. 2C by the arrows extending from the activity attribute(s) 210 and the display misalignment correction operation(s) 204 to the correction application attribute(s) 214).

Correction application attribute(s) 214 may comprise various components, such as correction restraint 216, speed of correction 218, timing of correction 220, and/or others. Correction restraint 216 may comprise whether application of display misalignment correction operation(s) 204 should be substantially immediate (e.g., performed without accounting for activity attribute(s) 210) or at least partially restrained (e.g., performed in a manner that accounts for activity attribute(s) 210). Correction restraint 216 may be determined based upon the type of display misalignment correction operation(s) 204 to be performed for display of content on the HMD 200. For instance, vertical disparities arising from misalignments in pitch can be associated with extreme user discomfort, which can increase the desirability of immediate performance of display misalignment correction operation(s) 204 with a substantial or predominant pitch component 204B.

Thus, in some instances, the HMD 200 (or any system) is configured to select a correction restraint 216 that causes unrestrained application of the display misalignment correction operation(s) 204 when the display misalignment correction operation(s) 204 include a pitch component 204B that satisfies one or more pitch thresholds (e.g., regardless of how activity attribute(s) 210 might otherwise influence the correction application attribute(s) 214, as described below). Put differently, systems may refrain from causing restrained application of the display misalignment correction operation(s) 204 when the display misalignment correction operation(s) 204 include a pitch component 204B that satisfies one or more pitch thresholds.d

In some instances, correction restraint 216 is additionally or alternatively influenced by activity attribute(s) 210. For instance, where motion attribute(s) 212 indicate satisfaction of a high threshold amount of motion, the correction restraint 216 may be selected to cause unrestrained (e.g., substantially immediate) application of the display misalignment correction operation(s) 204 (e.g., regardless of the type or character of the display misalignment correction operation(s) 204 to be applied).

In some implementations, systems are configured to enable restrained application of display misalignment correction operation(s) 204 based upon the activity attribute(s) 210 and/or the type or character of the display misalignment correction operation(s) 204 to be performed. For example, as noted above, correction application attribute(s) 214 may comprise speed of correction 218 and/or timing of correction 220. The speed of correction 218 may define the rapidity, rate, gradualness, or abruptness at which the display misalignment correction operation(s) 204 are applied to correct presentation of content on the HMD 200. A high speed of correction 218 may cause changes to the hologram/virtual object position/presentation to appear instantaneous or quick (e.g., presenting as a rapid shift or transformation of the hologram/virtual object), whereas a low speed of correction may cause changes to the hologram/virtual object position/presentation to appear gradual or slow (e.g., presenting as a slow shift or transformation of the hologram/virtual object).

In some instances, the speed of correction 218 is selected based upon the activity attribute(s) 210, such as the motion attribute(s) 212 of the HMD 200. For example, an amount of motion indicated by the motion attribute(s) 212 and the speed of correction 218 may be positively related, such that an increased speed of correction 218 is selected responsive to a detected high amount of motion, and a decreased speed of correction 218 is selected responsive to a detected low amount of motion. During high amounts of motion, users' focus and/or gaze on holograms/virtual content is often less intent, providing an opportunity to enact faster display misalignment correction operations 204 (e.g., via selection of a high speed of correction 218). In contrast, during low amounts of motion, user focus and/or gaze on holograms/virtual content is often more intent, which may cause abrupt corrections to hologram/virtual object presentation to be disruptive to the user experience. A low speed of correction 218 may be selected in such situations to render the application of the display misalignment correction operation(s) 204 more gradual and less disruptive to user experiences.

The relationship between the speed of correction 218 and the amount of motion indicated by the motion attribute(s) 212 may be defined in any suitable manner, such as by a linear or other function, by a set of thresholds (e.g., threshold amounts of motion being associated with corresponding, respective speeds of correction 218, with higher threshold amounts of motion being associated with higher speeds of correction 218), etc.

Modifying the speed of correction 218 based upon the motion attribute(s) 212 may be beneficial for at least some types of display misalignment correction operation(s) 204. For example, when the display misalignment correction operation(s) 204 include or are predominated by a yaw component 204A (and/or when the pitch component 204B is sufficiently small) and the motion attribute(s) 212 indicate a low amount of motion, a low speed of correction 218 may be selected to prevent user distraction/discomfort caused by abrupt changes to hologram presentation. In contrast, when the display misalignment correction operation(s) 204 include or are predominated by a yaw component 204A (and/or when the pitch component 204B is sufficiently small) and the motion attribute(s) 212 indicate a high amount of motion, a high speed of correction 218 may be selected to avoid or reduce motion-related artifacts such as swim or hologram instability, thereby enable fast-locking of holograms.

In some instances, the speed of correction 218 is selectively modified as discussed above in response to detection that the display misalignment correction operation(s) 204 includes a pitch component 204B that fails to satisfy a pitch threshold (e.g., a threshold for causing unrestrained or substantially immediate application of the display misalignment correction operation(s) 204).

In some instances, a system may refrain from applying display misalignment correction operation(s) 204 until threshold motion attribute(s) 212 are satisfied. For example, when the display misalignment correction operation(s) 204 omit a pitch component 204B (or include a sufficiently low pitch component 204B), a system may abstain from applying the display misalignment correction (e.g., thereby modifying the timing of correction 220) until a threshold amount of motion is detected for the system (e.g., the HMD 200).

One will appreciate, in view of the present disclosure, that activity attribute(s) 210 and the nature or character of the display misalignment correction operation(s) 204 to be applied may be used individually or in combination to determine the correction application attribute(s) 214 that will be used to apply the display misalignment correction operation(s) 204 to modify the display of content on the HMD 200 (or other system). Furthermore, one will appreciate, in view of the present disclosure, that any number of correction application attribute(s) 214 may be determined and/or used in various implementations of the disclosed principles. For example, a correction restraint 216 may comprise an initially determined attribute, which, if selected to enable restrained application of the display misalignment correction operation(s) 204, may lead to selection of an appropriate speed of correction 218 and/or timing of correction 220.

FIG. 2D illustrates action block 230, which conceptually represents performing display misalignment correction operation(s) 204 in accordance with the correction application attribute(s) 214 (e.g., represented by the arrows extending from the display misalignment correction operation(s) 204 and the correction application attribute(s) 214 to action block 230 in FIG. 2D). By utilizing dynamically determined correction application attribute(s) 214 (e.g., based upon activity attribute(s) 210 and/or the nature or character of the display misalignment correction operation(s) 204 to be performed) to apply display misalignment correction operation(s) 204, systems of the present disclosure may implement stereoscopic display misalignment correction functionality in a manner that advantageously reduces or avoids disruption to user experiences caused by the correction operations themselves.

### Example Method(s) for Facilitating Display Misalignment Correction

The following discussion now refers to a number of methods and method acts that may be performed in accordance with the present disclosure. Although the method acts are discussed in a certain order and illustrated in a flow chart as occurring in a particular order, no particular ordering is required unless specifically stated, or required because an act is dependent on another act being completed prior to the act being performed. One will appreciate that certain embodiments of the present disclosure may omit one or more of the acts described herein.

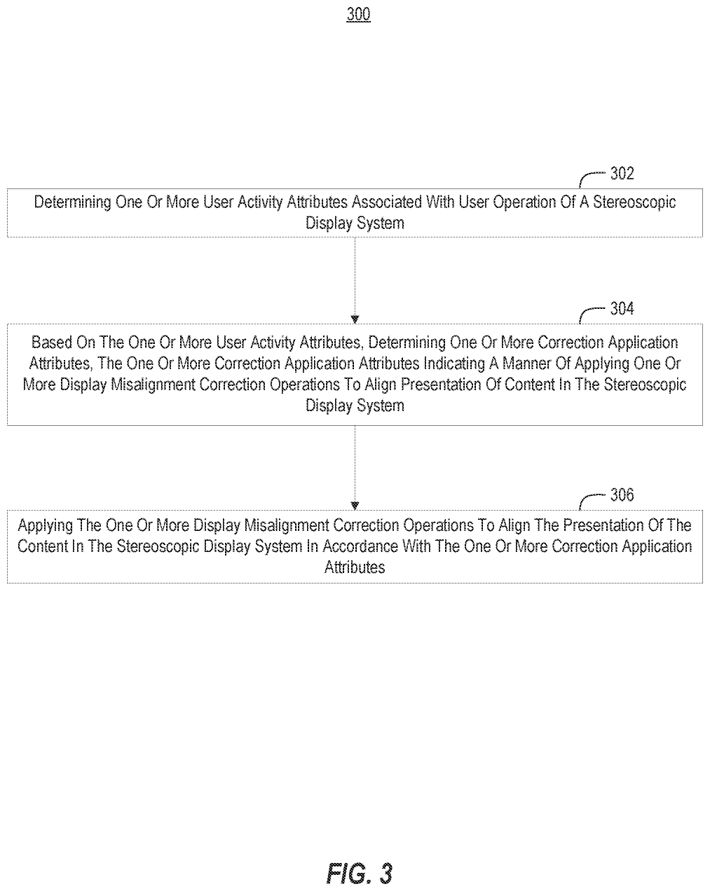

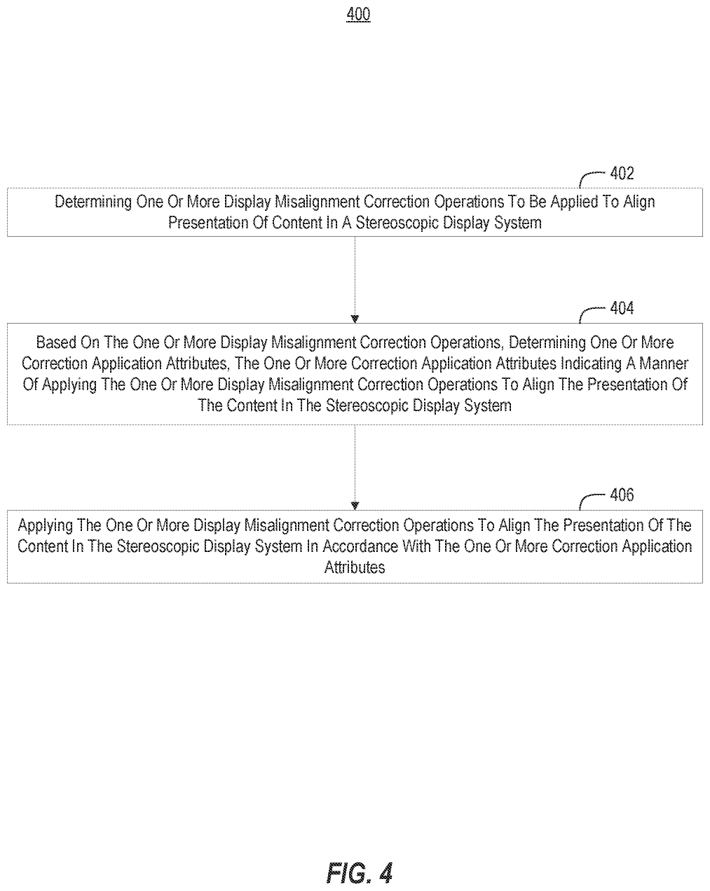

FIGS. 3 and 4 illustrate example flow diagrams 300 and 400, respectively, depicting acts associated with facilitating display misalignment correction, in accordance with implementations of the present disclosure.

Act 302 of flow diagram 300 of FIG. 3 includes determining one or more user activity attributes associated with user operation of a stereoscopic display system. Act 302 is performed, in some instances, utilizing one or more components of a system 100, such as processor(s) 102, storage 104, sensor(s) 110, I/O system(s) 114, communication system(s) 116, and/or other components. In some instances, the one or more user activity attributes comprise an amount of user motion. In some instances, determining the one or more user activity attributes comprises determining whether the amount of user motion satisfies one or more user motion thresholds.

Act 304 of flow diagram 300 includes, based on the one or more user activity attributes, determining one or more correction application attributes, the one or more correction application attributes indicating a manner of applying one or more display misalignment correction operations to align presentation of content in the stereoscopic display system. Act 304 is performed, in some instances, utilizing one or more components of a system 100, such as processor(s) 102, storage 104, sensor(s) 110, I/O system(s) 114, communication system(s) 116, and/or other components. In some instances, the one or more correction application attributes comprise a speed of correction. The amount of user motion and the speed of correction may be positively related. In some implementations, determining the one or more correction application attributes comprises selecting the speed of correction from a plurality of speeds of correction based upon the one or more user motion thresholds satisfied by the amount of user motion. The plurality of speeds of correction and the one or more user motion thresholds may be positively related. In some instances, determining the one or more correction application attributes is further based upon the one or more display misalignment correction operations to be applied.

In some implementations, in response to determining that the pitch component satisfies one or more pitch thresholds, the one or more correction application attributes cause unrestrained application of the one or more display misalignment correction operations. In some implementations, in response to determining that the pitch component satisfies the one or more pitch thresholds, the one or more correction application attributes refrain from causing restrained application of the one or more display misalignment correction operations based upon an amount of user motion indicated by the one or more user activity attributes. In some implementations, in response to determining that the pitch component fails to satisfy one or more pitch thresholds, the one or more correction application attributes are determined based upon an amount of user motion indicated by the one or more user activity attributes. In some implementations, in response to determining that the pitch component fails to satisfy one or more pitch thresholds, the one or more correction application attributes cause abstention of applying the one or more display misalignment correction operations until an amount of user motion indicated by the one or more user activity attributes satisfies one or more user motion thresholds.

Act 306 of flow diagram 300 includes applying the one or more display misalignment correction operations to align the presentation of the content in the stereoscopic display system in accordance with the one or more correction application attributes. Act 306 is performed, in some instances, utilizing one or more components of a system 100, such as processor(s) 102, storage 104, sensor(s) 110, I/O system(s) 114, communication system(s) 116, and/or other components. Such functionality may effectuate display misalignment correction in a manner that mitigates user discomfort.

Act 402 of flow diagram 400 of FIG. 4 includes determining one or more display misalignment correction operations to be applied to align presentation of content in a stereoscopic display system. Act 402 is performed, in some instances, utilizing one or more components of a system 100, such as processor(s) 102, storage 104, sensor(s) 110, I/O system(s) 114, communication system(s) 116, and/or other components. In some instances, the one or more display misalignment correction operations comprise a pitch component and/or a yaw component.

Act 404 of flow diagram 400 includes, based on the one or more display misalignment correction operations, determining one or more correction application attributes, the one or more correction application attributes indicating a manner of applying the one or more display misalignment correction operations to align the presentation of the content in the stereoscopic display system. Act 404 is performed, in some instances, utilizing one or more components of a system 100, such as processor(s) 102, storage 104, sensor(s) 110, I/O system(s) 114, communication system(s) 116, and/or other components. In some implementations, in response to determining that the pitch component satisfies one or more pitch thresholds, the one or more correction application attributes cause unrestrained application of the one or more display misalignment correction operations, regardless of an amount of user motion associated with operation of the stereoscopic display system. In some implementations, in response to determining that the pitch component fails to satisfy one or more pitch thresholds, (i) the one or more correction application attributes are determined based upon an amount of user motion associated with operation of the stereoscopic display system, or (ii) the one or more correction application attributes cause abstention of applying the one or more display misalignment correction operations until the amount of user motion associated with the operation of the stereoscopic display system satisfies one or more user motion thresholds.

Act 406 of flow diagram 400 includes applying the one or more display misalignment correction operations to align the presentation of the content in the stereoscopic display system in accordance with the one or more correction application attributes. Act 406 is performed, in some instances, utilizing one or more components of a system 100, such as processor(s) 102, storage 104, sensor(s) 110, I/O system(s) 114, communication system(s) 116, and/or other components. Such functionality may effectuate display misalignment correction in a manner that mitigates user discomfort.

### Additional Details Related to Computing Systems

Disclosed embodiments may comprise or utilize a special purpose or general-purpose computer including computer hardware, as discussed in greater detail below. Disclosed embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope

We claim:

1. A system for facilitating display misalignment correction, comprising:
one or more processors; and
one or more hardware storage devices storing instructions that are executable by the one or more processors to configure the system to:
determine one or more user activity attributes associated with user operation of a stereoscopic display system;
based on the one or more user activity attributes, determine one or more correction application attributes, the one or more correction application attributes indicating a manner of applying one or more display misalignment correction operations to align presentation of content in the stereoscopic display system; and
apply the one or more display misalignment correction operations to align the presentation of the content in the stereoscopic display system in accordance with the one or more correction application attributes, thereby effectuating display misalignment correction in a manner that mitigates user discomfort.

2. The system of claim 1, wherein the one or more user activity attributes comprise an amount of user motion.

3. The system of claim 2, wherein the one or more correction application attributes comprise a speed of correction.

4. The system of claim 3, wherein the amount of user motion and the speed of correction are positively related.

5. The system of claim 3, wherein determining the one or more user activity attributes comprises determining whether the amount of user motion satisfies one or more user motion thresholds.

6. The system of claim 5, wherein determining the one or more correction application attributes comprises selecting the speed of correction from a plurality of speeds of correction based upon the one or more user motion thresholds satisfied by the amount of user motion.

7. The system of claim 6, wherein the plurality of speeds of correction and the one or more user motion thresholds are positively related.

8. The system of claim 1, wherein the instructions are executable by the one or more processors to configure the system to:
determine the one or more display misalignment correction operations to be applied to align the presentation of the content in the stereoscopic display system.

9. The system of claim 8, wherein determining the one or more correction application attributes is further based upon the one or more display misalignment correction operations to be applied.

10. The system of claim 9, wherein the one or more display misalignment correction operations comprise a pitch component and/or a yaw component.

11. The system of claim 10, wherein, in response to determining that the pitch component satisfies one or more pitch thresholds, the one or more correction application attributes cause unrestrained application of the one or more display misalignment correction operations.

12. The system of claim 11, wherein, in response to determining that the pitch component satisfies the one or more pitch thresholds, the one or more correction application attributes refrain from causing restrained application of the one or more display misalignment correction operations based upon an amount of user motion indicated by the one or more user activity attributes.

13. The system of claim 10, wherein, in response to determining that the pitch component fails to satisfy one or more pitch thresholds, the one or more correction application attributes are determined based upon an amount of user motion indicated by the one or more user activity attributes.

14. The system of claim 10, wherein, in response to determining that the pitch component fails to satisfy one or more pitch thresholds, the one or more correction application attributes cause abstention of applying the one or more display misalignment correction operations until an amount of user motion indicated by the one or more user activity attributes satisfies one or more user motion thresholds.

15. The system of claim 1, wherein the system comprises the stereoscopic display system.

16. A system for facilitating display misalignment correction, comprising:
one or more processors; and
one or more hardware storage devices storing instructions that are executable by the one or more processors to configure the system to:
determine one or more display misalignment correction operations to be applied to align presentation of content in a stereoscopic display system;
based on the one or more display misalignment correction operations, determine one or more correction application attributes, the one or more correction application attributes indicating a manner of applying the one or more display misalignment correction operations to align the presentation of the content in the stereoscopic display system; and
apply the one or more display misalignment correction operations to align the presentation of the content in the stereoscopic display system in accordance with the one or more correction application attributes, thereby effectuating display misalignment correction in a manner that mitigates user discomfort.

17. The system of claim 16, wherein the one or more display misalignment correction operations comprise a pitch component and/or a yaw component.

18. The system of claim 17, wherein, in response to determining that the pitch component satisfies one or more pitch thresholds, the one or more correction application attributes cause unrestrained application of the one or more display misalignment correction operations, regardless of an amount of user motion associated with operation of the stereoscopic display system.

19. The system of claim 17, wherein, in response to determining that the pitch component fails to satisfy one or more pitch thresholds,
the one or more correction application attributes are determined based upon an amount of user motion associated with operation of the stereoscopic display system, or
the one or more correction application attributes cause abstention of applying the one or more display misalignment correction operations until the amount of user motion associated with the operation of the stereoscopic display system satisfies one or more user motion thresholds.

20. A method for facilitating display misalignment correction, comprising:
determining one or more user activity attributes associated with user operation of a stereoscopic display system;
based on the one or more user activity attributes, determining one or more correction application attributes, the one or more correction application attributes indicating a manner of applying one or more display misalignment correction operations to align presentation of content in the stereoscopic display system; and
applying the one or more display misalignment correction operations to align the presentation of the content in the stereoscopic display system in accordance with the one or more correction application attributes, thereby effectuating display misalignment correction in a manner that mitigates user discomfort.
